(19) United States
(12) Patent Application Publication
(10) Pub. No.: US 2007/0063510 A1
(43) Pub. Date: Mar. 22, 2007

(54) Protective sleeve for pipe joint infill cladding

(75) Inventor: Guy G. Gronquist, Katy, TX (US)

Correspondence Address: ALBERT B. KIMBALL, JR.;BRACEWELL & PATTERSON L L P, 711 LOUISANA SUITE 2300, HOUSTON, TX, 77002, US

(73) Assignee: Offshore Joint Services, Inc.

(21) Appl. No.: 11/544,517

(22) Filed: Oct. 6, 2006

Related U.S. Application Data
(63) Continuation-in-part of application No. 11/231,449, filed on Sep. 21, 2005.
(63) Continuation-in-part of application No. 11/231,558, filed on Sep. 21, 2005.

(51) Int. Cl. F16L 47/00; F16L 53/00; F16L 59/16

(52) U.S. Cl. 285/294.2; 285/41; 285/55; 285/294.1

(57) ABSTRACT

A protective sleeve is applied as a permanent outer cladding shield over a joint infill at the welded end portions of adjacent coated sections of pipe for a pipeline in or beneath a body of water. The sleeve once installed forms a seal against entry of water to protect the pipe from corrosion. The sleeve takes the form of a sheet of synthetic resin mounted to form a cylinder about the area to receive the joint infill. An electrically conductive mesh or wire element mounted with the sheet is provided with electrical current to fuse circumferential portions of the sleeve to the weight-coated cover sections of the pipe and to fuse longitudinal portions of the sleeve together. A coating of synthetic resin is applied onto bonded adjacent portions of the cylindrical sleeve and overlapping end portions of the sleeve and the portions of the coated pipe sections to further seal the sleeve over the pipe joint.

### CROSS-REFERENCE TO RELATED APPLICATIONS

The present application relates to joint infill cladding of pipeline joints, and is a continuation-in-part of each of the following commonly-owned U.S. patent applications Ser. No. 11/231,449 entitled “Joint Infill Cladding and Method of Applying Same” (Attorney Docket No. 085356.000020); and Ser. No. 11/231,558 entitled “Joint Infill Cladding Applicator Clamp” (Attorney Docket No. 085356.000023), each filed 21 Sep. 2005, and of which applicant is inventor, and each of which is incorporated herein by reference.

1. Field of the Invention

The present invention relates generally to providing water impenetrable outer cladding, and to methods of installing such cladding, to outer pipeline coatings to better protect of joint infill coatings applied to exposed ends of coated pipeline to be laid in bodies of water.

2. Background

It is conventional in the offshore pipeline industry to use weighted coated pipe on pipelines which are being laid on or under the floors of bodies of water. Originally, the weight coatings of each section or length of pipe were of concrete with end metal portions of the pipe left bare or unprotected. The end portions of adjacent lengths of pipe were welded together on a pipe laying barge as the pipeline was being formed. The bare metal was then covered with a film or sheet of corrosion resistant material. A joint infill resulting from injection of chemicals which reacted and formed an open cell polyurethane foam was then used to fill the annular socket or space between weight coatings. U.S. Pat. Nos. 5,900,195 and 6,402,201, each commonly owned by the assignee of the present application, are examples of this open cell foam infill technology.

More recently, the pipe lengths have been weight coated with a solid synthetic resin, usually being polypropylene and polyethylene synthetic resin coatings to serve as thermal insulation. This has been increasingly the case as offshore production has moved into deeper portions of bodies of water. In some cases a concrete weight coating has been applied on top of the synthetic resin insulation. A similar solid synthetic resin was also desired for the joint infill material. Solid synthetic resins are impenetrable by water; however, concerns have been raised about water ingress through even the relatively small spaces or gaps between the joint infill and the synthetic resin insulation coatings. This has been a particular concern due to the increased hydrostatic pressures beneath bodies of water, particularly in deeper bodies of water.

Other patents, such as U.S. Pat. No. 6,059,319, were directed to forming a cylindrical sleeve seal over the gap between adjacent lengths of plastic coated pipe. Filler panels of butyl rubber, bitumastic, rubberized bitumen or similar materials of a size approximating the interior space within the cylindrical sleeve were used in an attempt to provide corrosion protection. However, gaps and spaces were often present between the various elements, such as between the filler panel material, the pipe coating and the cylindrical sleeve seal. There was thus a risk of fluid leakage and corrosion. For offshore pipelines, particularly in deeper bodies of water, the hydrostatic pressures increased the concerns of fluid leakage through these gaps and spaces and resulting possible corrosion.

### SUMMARY OF THE INVENTION

Briefly, the present invention provides a new and improved method of applying a protective outer cladding over welded end stubs of coated sections of pipe for a pipeline. A sheet of synthetic resin with an electrically conductive element about is applied to form a cylindrical sleeve about the welded end portions. The sleeve also overlaps onto end portions of the coated pipe sections adjacent the end stubs. The electrically conductive element is connected to a source of electrical current. Chemical components are introduced into the interior of the cylindrical sleeve to allow a synthetic resin to form and fill the interior of the sleeve as joint infill insulation between the adjacent pipe sections. Electrical current is then sent into the electrically conductive element to heat adjacent portions of the cylindrical sleeve to bond the sheet together with the weight coating and to seal the sleeve over the joint infill coating. A synthetic resin is then applied by flame spraying onto bonded adjacent portions of the cylindrical sleeve and overlapping end portions of the sleeve and end portions of the coated pipe sections to further seal the cladding to the pipeline.

The present invention also provides a new and improved protective shield over joint infill on coated pipe sections for a pipeline. The coated sections may include insulation coating and weight coating. The synthetic resin portions of the pipeline in a preferred embodiment are coated with a synthetic resin weight coating, and the synthetic resin formed during the step of introducing components is preferably a solid polyurethane which bonds with the synthetic resin coating along the length of the pipe.

To better understand the characteristics of the invention, the description herein is attached, as an integral part of the same, with drawings to illustrate, but not limited to that, described as follows.

### BRIEF DESCRIPTION OF THE DRAWINGS

A better understanding of the present invention can be obtained when the detailed description set forth below is reviewed in conjunction with the accompanying drawings, in which:

FIG. 1 is an isometric view of a pipe joint before application of a joint infill cover and cladding sleeve according to the present invention.

FIGS. 2, 3, 4 and 5 are isometric views of cladding sleeves installed over a joint infill applied to a pipe joint like that shown in FIG. 1.

FIGS. 6 and 7 are isometric views of a clamp according to the present invention located over a cladding sleeve of the type shown in FIG. 2, 3, 4 or 5.

FIG. 8 is a schematic diagram of a synthetic resin sealant coating being applied to a cladding sleeve according to the present invention.

To better understand the invention, a detailed description of some of the modalities, as shown in the drawings for illustrative but not limiting purposes, is included as part of the description herein.

### DETAILED DESCRIPTION

Although the following detailed description contains many specific details for purposes of illustration, anyone of ordinary skill in the art will appreciate that many variations and alterations to the following details are within the scope of the invention. Accordingly, the exemplary embodiment of the invention described below is set forth without any loss of generality to, and without imposing limitations thereon, the claimed invention.

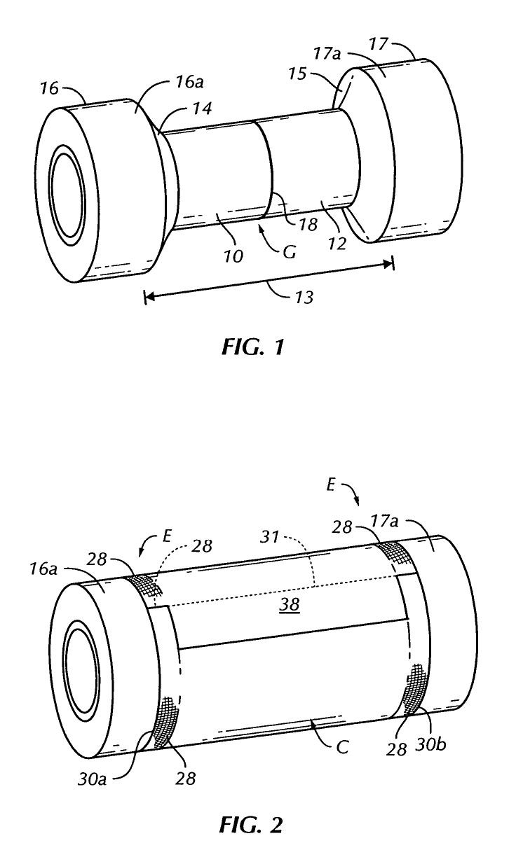

In the drawings, a gap G (FIG. 1) is shown at welded end portions 10 and 12 of a pipeline P during the process of a pipeline laying operation. The welded end portions or stubs 10 and 12 are located between coatings 14 and 15 which are enclosed within outer cover sleeves 16 and 17 of the pipeline P. The dimensions of the sheet are also such that it extends laterally or transversely as indicated at 13 a sufficient distance to circumferentially enclose the gap G (FIG. 1) with adequate overlap of portions of the wrapped sheet onto the cover sleeves 16 and 17 to allow sealing according to the present invention.

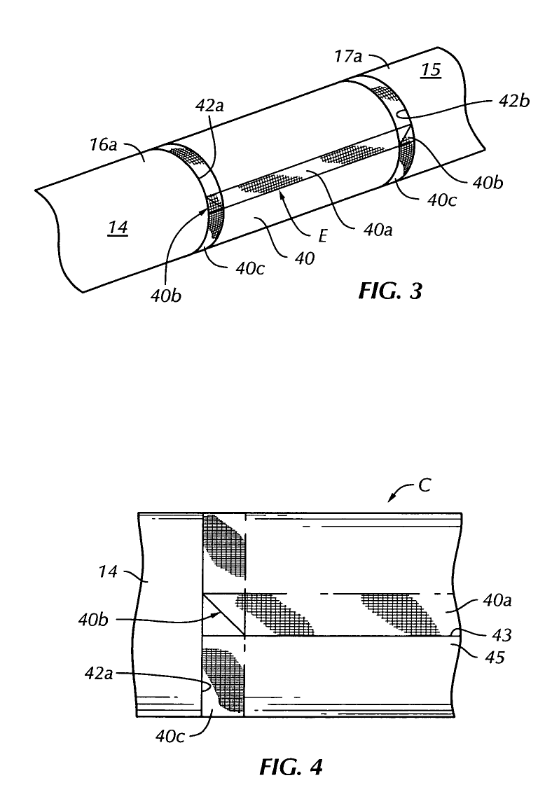

According to the present invention, a cylindrical sleeve C is formed from a flat rectangular sheet of a suitable synthetic resin, such as polypropylene or polyethylene. The synthetic resin material of the sleeve has a typical thickness from about 0.125″ to 0.5″ or larger which is wrapped into the cylindrical sleeve C in order to be applied as protective cladding (FIGS. 2, 3, 4 and 5) in conjunction with joint infill in the gap G between the cover sleeves 16 and 17 of the pipeline P.

According to the present invention, the sheet is wrapped about the pipeline P form the cylindrical sleeve C (FIGS. 2, 3, 4 and 5) which is a protective outer cladding shield over a weld joint 18 (FIG. 1) formed between the welded end portions 10 and 12 adjacent the cover sleeves 16 and 17 of the pipeline P. The coatings 14 and 15 applied to the pipeline are a suitable, fluid impenetrable, hard, high-density synthetic resin such as a high-density polypropylene or polyethylene, also known as HDPP or HDPE, respectively. It should be understood that, if described, a number of other water impenetrable resins may be used in place of HDPP or HDPE.

The coatings 14 and 15 are factory applied and serve to provide thermal insulation for the fluids transported through the pipeline. If desired, an outer weight coating of concrete may be applied as a weight coating as a part of coatings 14 and 15 on top of the thermal insulative HDPE or HDPP.

As is conventional, the end portions 10 and 12 of the pipe sections 16 and 17 are welded together to form the weld joint 18. The exposed end or stub portions 10 and 12 of the pipe sections 16 and 17, respectively, in the area of the gap G are not weight coated prior to the welding of sections 10 and 12 together. If desired, a thin corrosion protective coating may be installed over the end portions 10 and 12 after the weld joint 18 is formed and the weld area and end portions cleaned.

The dimensions of the cover sleeve C are such that the sleeve C extends as has been discussed laterally a sufficient distance 13 to span the gap G and overlap end portions 16a and 17a of the coatings 16 and 17, and the circumferential extent of the sleeve S is such that a longitudinal seam 31 is formed between overlapping edge portions of the sleeve S extending along the direction of the pipeline P.

Sizes of the sleeve C can vary to accommodate a range of pipe sizes, for example 2″ thru 60″ outer diameters. The sleeve C in most cases is preferably pre-abraded on an inside surface 30. If desired, the inside surface of the sleeve C may be factory corona-treated, or treated in the field by means of flame treatment, or both, to enhance the bond at the interface of the inside of the sleeve C with the solid polyurethane infill that is formed in the annulus 24.

When the cylindrical sleeve C is in place, an annulus or cylindrical space is formed within the interior of the sleeve C about the exposed pipe sections 10 and 12 adjacent the weld joint 18. As has been described, the sleeve C overlaps the end portions 16a and 17a and is longitudinally closed along the seam 31 to form seals for the annulus.

The annulus is preferably filled such as by pouring, injection or the like with a chemical composition such as a suitable synthetic resin, in the form of a polyurethane or epoxy which sets or hardens in the annulus to form a HDPE or other hard synthetic resin infill. As an alternative, chemical components which mix and then harden to form a hard polyurethane or epoxy joint infill for insulation may be injected into the annulus. The composition or components which form the joint infill also bond with the adjacent weight coatings 14 and 15 of the pipeline P and also with synthetic resin interior surface portions of the sleeve S. Due to such bonding, no flow path for water ingress is formed between the end portions 10 and 12 adjacent weld joint in the pipeline P.

The sheet has an electrically conductive element E mounted or integrally formed therewith prior to being formed into the cylindrical sleeve C. According to the present invention, the electrically conductive element E may be of a variety of types. For example, as shown in FIG. 2, the sleeve C can be formed with an electrically conductive element E including a pair or set of circumferentially extending electrically conductive elements strips or bands 28 of a welding element/mesh. The electrically conductive welding strips or bands 28 are located at side edges 30a, 30b on the interior surface of the flat sheet which is formed into the cylindrical sleeve C. The electrically conductive welding elements 28 are pre-attached, such as by means of tack welding, to locations on the side edges 30a, 30b. The welding elements 28 are formed of a suitable conductive metallic material, such as a number of alloys including stainless steel, nickel-chromium, aluminum, copper, copper-tin, or other electrically conductive material. It should be understood that the foregoing materials for the welding element 28 are given by way of example, and that others may be used, if desired.

The welding elements 28 in response to the flow of electrical current through the metallic material heat and melt the adjacent synthetic resin materials. The heated, melted synthetic resin bonds overlapping or adjacent portions of the cylindrical sleeve C together and also to the weight coatings 16 and 17. When the sleeve S is formed into the cylindrical sleeve C and heated by welding elements 28, the end or edge portions 30a and 30b provide circumferential bonding together of the coiled cylindrical portions of the sleeve C at each end of the annulus. The circumferential end portions 30a and 30b also bond the sleeve C circumferentially to the coated portions 16 and 17, respectively, and form circumferential seams 32a and 32b.

The longitudinal seam 31 in the cover sleeve C may be formed in several ways. As disclosed in commonly owned, co-pending U.S. patent application Ser. No. 11/231,449, a flap 38 is formed along one of the longitudinally extending side edges of the sleeve C. The flap 38 forms a longitudinal temporary cover along an area of a longitudinal seam 31 along the longitudinally extending side edge portions when the synthetic resin sheet is wrapped about the coated portions 16 and 17 to form the cylindrical sleeve C. As disclosed in co-pending application Ser. No. 11/231,449 previously mentioned, the longitudinal seam 31 may then be covered with a longitudinal sealing strip, as described in such application.

Electrically conductive contacts or leads are installed or attached at ends of each conductive strip or band 28 to connect the bands 28 to a suitable power supply so that electrical current may be provided from the power supply to the conductive strip welding element or band 28. The end portions of each conductive strip 28 are located so that when the cylindrical sleeve C is formed on the pipeline, such end portions are spaced from each other on opposite sides of the longitudinal seam in the sleeve C.

It should be also understood that the electrical conductive bands 28 may be connected to the source of electrical current in other manners, such as those disclosed in the previously referenced co-pending applications which are incorporated herein by reference. Example alternatives could be removable conductive probes or contacts which are separately insertable and removable. When electrical current flows in the bands 28, the synthetic resin materials of the sleeve areas 16a and 17a and of the cover sleeve C bond or weld together and a circumferential synthetic resin bond is formed in the areas of the elements 28 and seams 32a and 32b.

As shown in FIGS. 3, 4 and 5, the electrically conductive element E may also take the form of a continuous U-shaped strip or band 40 of a welding element/mesh like that disclosed in commonly owned, co-pending U.S. patent application Ser. No. 11/231,558, which as noted previously is incorporated by reference herein for all purposes. The U-shaped strip or band 40 is formed of a longitudinally extending base or central portion 40a folded at corners 40b from which extend two circumferentially extending arms or bands 40c to thus form a U-shape to extend along the three edges of the cover sleeve C. The welding element 40 is pre-attached, such as by means of tack welding, at a number of spaced locations along the three edges on the periphery of an interior surface of the sheet which is formed into the cover sleeve C.

The U-shaped welding element 40 is formed of a suitable conductive metallic material of the types used in elements 28, such as a number of alloys including stainless steel, nickel-chromium, aluminum, copper, copper-tin, or other electrically conductive material. It should again be understood that the foregoing materials for the welding element 40 are given by way of example, and that others may be used, if desired.

The U-shaped welding element 40 in response to the flow of electrical current heats and melts the adjacent synthetic resin materials. The heated, melted synthetic resin of the sleeve C and cover material 16 and 17 adjacent the circumferential arms or bands 40c bonds overlapping or adjacent portions of the cylindrical sleeve C together and also to the weight coatings 16 and 17. When the sleeve S is formed into the cylindrical sleeve C and heated by welding element 40, circumferential end or edge portions 42a and 42b of the sleeve C adjacent the heating bands 40c provide circumferential bonding together of the sleeve C at each end of the annulus. The circumferential end portions 42a and 42b of the cover sleeve C also bond circumferentially to the synthetic resin end portions 16a and 17a, respectively, of the pipeline P.

The central portion 40a of the U-shaped conductive heat strip 40 adjacent a longitudinally extending edge 43 of the sleeve C forms a longitudinal seal along a longitudinal seam area 45. The circumferential seals in the areas adjacent bands 40c are, as has been discussed, formed between the sleeve C and the end portions 16a and 17a at each end of the gap G. The weld areas formed by central portion 40a of the heating element 40 adjacent longitudinal seam 45 formed in the sleeve C extend longitudinally between the circumferential seals to seal the gap G.

Electrically conductive contacts or leads are installed or attached to connect the conductive strip or band 40 to a power supply in order that electrical current may be provided the conductive strip welding element 40. The leads are installed or attached to make contact on opposite end portions of the welding element 40 near the beginning and end of its U-shape. In some instances, the electrical conductive leads are formed to be connected with the conductive strip or band. As an alternative, removable conductive probes or contacts separately insertable and removable may be used.

End portions 40c of the U-shaped conductive welding strip 40 are located when the cylindrical sleeve C is formed on opposite sides of the annulus, with the longitudinal portion 40a of the U-shape extending longitudinally between adjacent overlapping portions of the cylindrical sleeve C. In this manner, the synthetic resin bond or weld formed when element 40 heats due to electrical current flow is one continuous synthetic resin bond from one end to the other end of the sleeve C. The bond so formed is located circumferentially at end portions 40c connected around two corners 40b by the central portion 40a which forms the longitudinal weld.

As discussed in co-pending U.S. patent application Ser. No. 11/231,558, a suitably located injection port is drilled or otherwise formed in the sleeve C. A solid polyurethane-forming material is then pumped or poured into the annulus until the volume of the annulus is full. The solid polyurethane material quickly reacts and changes state from liquid to solid, hardening and forming the fluid impenetrable joint infill.

As further described in co-pending U.S. patent application Ser. No. 11/231,558, after injection of the materials which form the joint infill, a longitudinal pressure pad is installed on top of an area of the sleeve C above the welding element/mesh 40 that creates the longitudinal section of the weld on the adjacent longitudinal edge portions of the sleeve C.

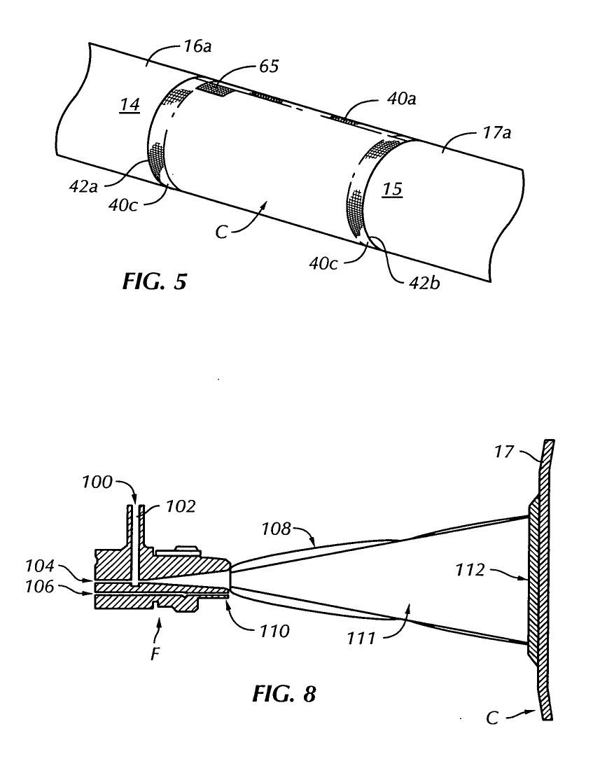

An injection port closure 65 (FIG. 5) of comparable material to the sleeve C and of a size to form a closure over the injection port is used for closure purposes. The closure 65 is furnished with a conductive wire mesh backing and is then installed over the injection port in the manner described in co-pending U.S. patent application Ser. No. 11/231,558.

FIGS. 2, 3, 4 and 5 show various forms of a finished joint infill shield according to the prior co-pending U.S. patent applications previously mentioned. The present invention forms the protective shield or cover sleeve C for the joint infill. As disclosed above, no fluid path from the exterior of the sleeve C to the pipeline P is present within the infill. With the present invention, a synthetic resin is applied by flame spraying synthetic resin droplets onto target areas on the cover sleeve C. The target areas are the bonded adjacent longitudinal edge portions of the cylindrical cover sleeve C and onto seams 42a and 42b at overlapping circumferential end portions of the sleeve C and end portions 16a and 17a of the coated pipe sections 16 and 17. The synthetic resin droplets so applied during flame spraying on these target areas form into a fluid impenetrable coating to further seal the cladding sleeve to the pipeline P.

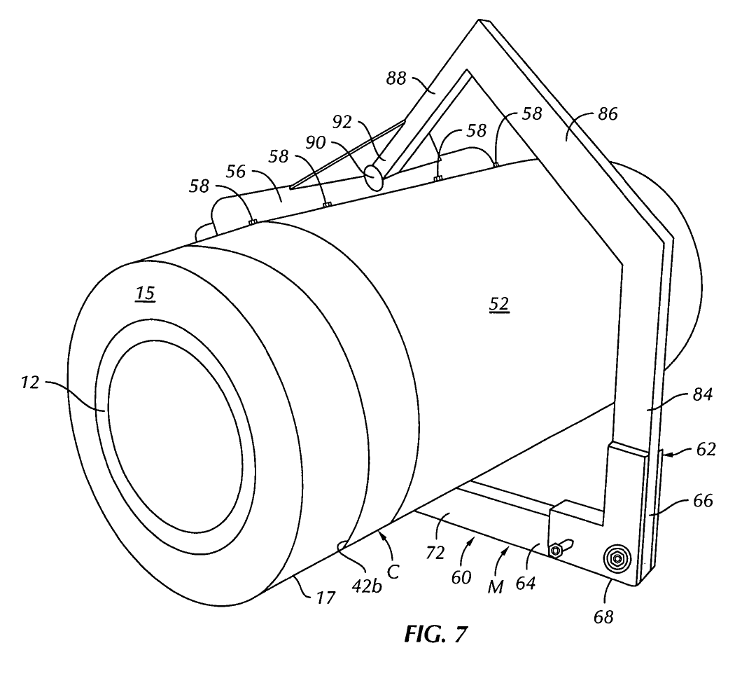

A clamp L (FIGS. 7 and 8) according to the present invention is mounted on the pipeline P in the location of the cover sleeve C. The clamp L serves to hold the heat fusible protective cladding sleeve C in sealing contact on the pipeline P as the coating of synthetic resin droplets is being applied to seams of the protective cladding sleeve C and the adjacent synthetic resin coated sections 16 and 17 of the pipe. The clamp L includes a clamp band B fitting circumferentially over portions of the cladding sleeve C leaving a longitudinal seam 50 between adjacent or overlapping longitudinal edges of the cladding sleeve C accessible to the synthetic resin droplets. The clamp L also includes a mounting mechanism M which brings the clamp band B into sealing contact with the cladding sleeve C.

The clamp band B is a strap or band 52 of steel or other suitable heat conductive metal or material of suitable strength having a circumferential extent allowing enclosure of the cover sleeve C with space for the longitudinally extending gap or space 50 between longitudinally extending edge portions 52a and 52b. The material of the strap or band 52 distributes heat from the flame spraying over the full outer surface of the cladding or cover sleeve C to reduce localization of heated areas or hot spots. The lateral extent of the strap 52 of the clamp band B is such that the circumferential seals at end portions 42a and 42b at the overlap of the cover sleeve C onto end portions 16a and 17a of the pipeline P are left accessible.

Attachment flanges 54 and 56 are mounted extending outwardly from the edge portions 52a and 52b of the band B. The attachment flanges 54 and 56 may be mounted to the band B with bolts 58 as shown in the drawings, although it should be understood that attachments may be made using studs, rivets or welding, if desired.

The mounting mechanism M includes a pair of closure arms 60 and 62 hingedly or pivotally mounted at their respective end portions 64 and 66 to each other by a connector pin or bolt 68. The closure arm 62 has a sleeve 67 formed extending outwardly from it end portion 66 to receive end portion 64 of the closure arm 60. A locking pin or lug 70 is inserted through suitable openings in the sleeve 67 and end portion 64 of the closure arm 60 to lock the arms 60 and 62 against pivotal movement with respect to each other when the band B is in position on the cover sleeve C.

The closure arm 60 has segments 72 and 74 extending from the end portion 64 to a threaded socket member or sleeve 76 at an outer end 78 of the arm segment 74. The dimensions and extent of the closure arm segments 72 and 74 are governed by the circumferential extent of the band B according to the outside diameter of the cover sleeve C and the pipe P.

A threaded pin or bolt or other suitable adjustment mechanism 80 is movably mounted in the socket 76 at the end 78 of the arm 60. The bolt 80 extends to a contact pad or mounting plate 82 mounted with the flange 54. The bolt has a head 80a which is engageable by a wrench or other grip in order to move in the socket 76 to adjust the relative spacing between the closure arm 60 and flange 54. In this manner, the amount of tension in the band B and thus the circumferential compressive force applied by the band B on the cover sleeve may be adjusted to the desired amount.

The closure arm 62 has segments 84, 86 and 88 extending from the end portion 66 to a connection 90 at an outer end 92 with the flange 56 mounted with the band B. The dimensions and extent of the closure arm segments 84, 86 and 88 are also governed by the circumferential extent of the band B according to the outside diameter of the cover sleeve C and the pipe P. A force distributing flange 94 is formed at the outer end 92 of segment 88 of the closure arm 62 to distribute forces from the band B across the lateral extent of the flange 56 along the extent of the cover sleeve C along the length of the pipe P.

In the operation of the present invention, the cover sleeve C and joint infill contents are formed as indicated in FIGS. 2, 3, 4 and 5 in the manner described in copending U.S. applications Ser. Nos. 11/231,449 and 11/231,558 which are incorporated herein by reference. The clamp band B is then located on the cover sleeve C and the bolt 80 adjusted to obtain the desired force level to be exerted on the cover sleeve. Application of a synthetic resin onto the bonded adjacent portions of the cover sleeve C and the overlap between the cover sleeve C and the coating sections 16 and 17 may then be performed.

Initially, the target areas for application of synthetic resin droplets to form a coating are preheated to provide increased bonding of the droplets onto those areas. During such preheating, the surface areas of the cover sleeve C accessible at the gap 50 where the longitudinal seam along the length of the cover sleeve C was present, as well as the area along the outer edges 42a and 42b of the cover sleeve C where there is overlap between the cover sleeve C and the coating sections 16 and 17 are subjected to heat treatment, usually by gas flame. This is done to prepare these areas of synthetic resin to receive the droplets of synthetic resin to be applied by flame spraying.

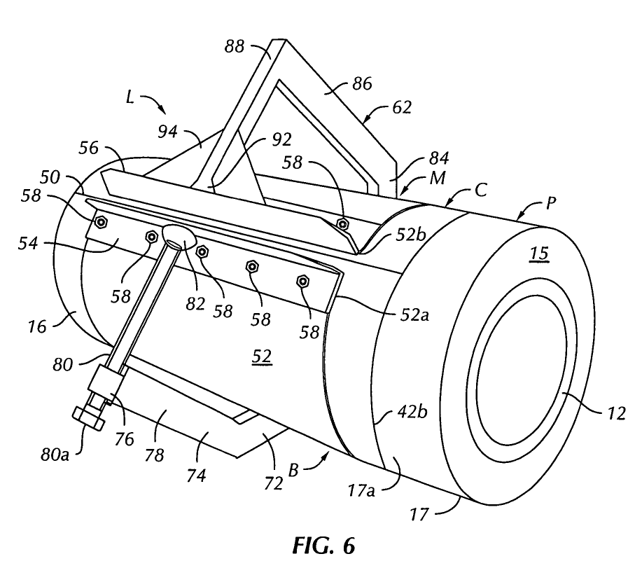

The synthetic resin droplets are applied by a powder flame spraying process as is illustrated schematically in FIG. 6 for the purposes of the present invention. A powder flame spraying gun F is shown. The gun F may be, for example, of the type available from XIOM Corporation, although it should be understood that other types may be used as well.

As illustrated in FIG. 6, a synthetic resin powder is provided as indicated at 100 through tubing from a suitable source to an inlet 102 of the flame spraying gun F. According to the present invention, the synthetic powder to be applied is preferably of a like type to the synthetic resin used in the cover sleeve and the covering 16 and 17. The powder entering the spray gun F may be fed by a stream of compressed gas, either air, nitrogen or some suitable inert gas. It should be understood that the powder may be fed by a venturi effect as well as a result of fuel gas flow caused by gases entering the spray gun F as indicated at inlet port 104, or an aspirating or carrier gas entering as indicated at 106.

The gases and powder entering the spray gun F pass through the spray gun F, and fuel gases are burned together to form a conical flame region as indicated schematically at 108. The heat so generated is at a level to also convert the individual powder granules into droplets of molten synthetic resin as the powder passes through the flame. The carrier or aspirating gases feed the synthetic resin powder into the flame region. The gun F also includes a region of outer nozzles as shown at 110 which form a stream of compressed gas about the flame region 108 to focus the flame and also direct the synthetic resin droplet particles onto the target portions of the cover sleeve C and the circumferential overlap of the cover sleeve C and the covering sections 16 and 17.

As indicated at 112, a coating is formed as the synthetic resin droplets accumulate on the target areas on the exterior surface of the cover sleeve C. The thickness of the resulting coating 112 is governed by the time duration and application rate of droplets during the flame spraying. The required thickness is a function of the depth of water for the pipeline P and subsurface tide or wave action. When the coating 112 is of the specified thickness and surface coverage area, flame spraying operations are stopped. The cover sleeve C and the applied coating 112 are subject to a water quench operation.

According to the present invention, a permanent outer cladding is formed by bonding of the synthetic resin materials together and application of the coating of synthetic resin in the target areas by flame spraying, in the manner described above. The sleeve 30 bonds to the infill I and also to the factory applied portions 16 and 17 of the pipeline P. The infill I also bonds to the factory coated the sleeve 30 also bonds to synthetic resin in the coated portions 16 and 17. The sleeve 30 also bonds to itself along the area of the longitudinal overlap along edge portion 30b. A synthetic resin coating 112 is then applied by flame spraying onto the target areas of the bonded adjacent portions of the cylindrical sleeve C and seams 32a and 32b at overlapping end portions of the sleeve and end portions of the coated pipe sections to further seal the cladding to the pipeline.

The joint in the pipeline P so formed is thus impermeable to water and in effect a hermetic seal. The joint formed according to the present invention provides an effective, water impermeable seal to the factory applied pipeline coatings and affords better protection for both the joint infill insulation and the pipeline insulation coatings.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

What is claimed is:

1. A method of applying protective cladding over welded end stubs of coated sections of pipe for a pipeline, comprising the steps of:
applying a sheet of synthetic resin with an electrically conductive element to form a cylindrical sleeve about the welded end portions and overlapping onto portions of the coated pipe sections adjacent the end stubs;
introducing components into the interior of the cylindrical sleeve to allow a synthetic resin to form and fill the interior of the sleeve as joint infill between the adjacent pipe sections;
attaching the electrically conductive element to a source of electrical current;
sending electrical current into the electrically conductive element to heat adjacent portions of the cylindrical sleeve to bond together and seal the sleeve over the joint infill; and
flame spraying a synthetic resin onto bonded adjacent portions of the cylindrical sleeve and the overlapping portions of sleeve and the portions of the coated pipe sections to further seal the sleeve over the pipe joint.

2. The method of claim 1, wherein the synthetic resin applied during the step of flame spraying is a like composition to that of the synthetic resin of the sleeve.

3. The method of claim 1, further including the step of applying pressure to the sleeve during the step of flame spraying.

4. The method of claim 1, further including the step of distributing heat over the sleeve during the step of flame spraying.

5. The method of claim 1, where the coated sections of pipe are insulation coated.

6. The method of claim 1, wherein the coated sections of pipe are weight-coated.

4. The method of claim 1, wherein the coated portions of the pipeline are coated with a synthetic resin coating.

5. The method of claim 4, wherein the synthetic resin joint infill formed during the step of introducing components bonds with the synthetic resin coating.

6. The method of claim 4, wherein the synthetic resin joint infill comprises a solid polyurethane.

7. The method of claim 4, wherein the synthetic resin joint infill comprises an epoxy.

8. The method of claim 1, further including the step of:
securing the sleeve in place on the coated sections of pipe with the electrically conductive element attached.

9. The method of claim 1, wherein the step of applying the sheet comprises applying the sheet with a portion of the electrically conductive element extending longitudinally with respect to the pipeline.

10. The method of claim 1, wherein the step of applying the sheet comprises applying the sheet with a portion of the electrically conductive element extending circumferentially about adjacent weight coated sections at their welded end portions.

11. A protective cladding over welded end portions of adjacent synthetic resin coated sections of pipe for a pipeline, comprising:
a sheet of synthetic resin applied to form a sleeve extending circumferentially to define an annulus about the welded end portions;
an electrically conductive element extending circumferentially about the weight coated pipe sections adjacent the annulus and longitudinally within the sleeve along the end section, the conductive element heating the synthetic resin sleeve to seal the annulus about the cavity and bonding the synthetic resin sleeve with the synthetic resin weight-coated sections;
a synthetic resin infill formed to fill the annulus within the sleeve by injecting components which reacts and forms a water impermeable infill; and
a protective synthetic film coating formed of droplets of heated synthetic resin powder applied by flame spraying to an outer surface of bonded adjacent portions of the sleeve and coated pipe sections to further seal the sleeve onto the joint infill.

12. The protective shield of claim 11, wherein the synthetic resin infill bonds with the synthetic resin sleeve.

13. The protective shield of claim 11, wherein the synthetic resin sleeve bonds with the coated sections.

14. The protective shield of claim 11, wherein the synthetic resin infill bonds with the synthetic resin coated sections.

15. The protective shield of claim 11, wherein the coated sections are insulated coated.

16. The protective shield of claim 11, wherein the coated sections are weight-coated.

17. The protective shield of claim 11, wherein the hard synthetic resin infill in the annulus comprises a hard polyurethane.

18. The protective shield of claim 11, wherein the hard synthetic resin infill in the annulus comprises an epoxy.

19. The protective shield of claim 11, wherein the electrically conductive element comprises a set of longitudinally spaced conductive strips extending circumferentially along an inner surface of the sleeve on each side of the annulus.

20. The protective shield of claim 11, wherein the electrically conductive element comprises a longitudinally extending conductive strip extending along a lateral edge of an inner surface of the sleeve.

21. A clamp for holding a heat fusible protective cladding sleeve in sealing contact on a protective cladding sleeve as a coating of synthetic droplets is being applied to seams of the protective cladding sleeve and a pipe joint of welded end portions of adjacent synthetic resin coated sections of the pipe, comprising:
a clamp band fitting circumferentially over portions of the cladding sleeve leaving a longitudinal seam between overlapping longitudinal edges of the cladding sleeve accessible to the droplets;
the clamp band having circumferentially spaced end portions defining a gap to allow the applicator clamp to be brought into position over the cladding sleeve on the pipeline;
the clamp band extending along the length of the cladding sleeve between end seams formed extending longitudinally between end portions of the cladding sleeve and the adjacent synthetic resin coated sections of the pipe; and
a mounting mechanism for bringing the clamp band into sealing contact with the cladding sleeve.
